(19) United States
(12) Patent Application Publication
(10) Pub. No.: US 2008/0111327 A1
(43) Pub. Date: May 15, 2008

(54) TRANSPORT DEVICE CAPABLE OF ADJUSTMENT TO MAINTAIN LOAD PLANARITY

(75) Inventors: James Rhodes, Las Vegas, NV (US); Matthew Priddy, Las Vegas, NV (US); Aidan J. Bradley, Westlake Village, CA (US); Jeff Anderson, Saugus, CA (US); Gabriel T. Manville, Santa Rosa, CA (US); Kevin T. Parent, Santa Barbara, CA (US); Frank K. Weigand, La Canada, CA (US)

Correspondence Address: BELL, BOYD, & LLOYD LLP, P.O. BOX 1135, CHICAGO, IL, 60690, US

(73) Assignee: Rhodes Design and Development Corporation, Las Vegas, NV (US)

(21) Appl. No.: 11/559,229

(22) Filed: Nov. 13, 2006

(51) Int. Cl. B60P 3/022; B62D 59/04; B60K 17/30

(52) U.S. Cl. 280/5.514; 414/679; 180/264; 414/800

(57) ABSTRACT

The present invention relates to a transport device for a load. The transport device includes at least one device configured to alter the orientation of the load relative to at least a portion of the transport device. At least one sensor is adapted to detect if at least one of the following occurs: the portion of the load becomes substantially non-planar and the portion of the load becomes substantially non-level. Electrical components are in communication with the sensor and are adapted to adjust the at least one device such that the portion of the load maintains at least one of the substantial planarity and the substantial levelness.

### RELATED APPLICATIONS

This application is related to U.S. application Ser. No. 11/431,196, entitled “Building Transport Device”, filed May 9, 2006, the entire contents of which are herein incorporated by reference.

### BACKGROUND

The prior art is generally directed to transporting a building or house by a flat bed delivery device, such as a truck or other device. The prior art delivery devices generally attempt to locate the buildings or houses onto or adjacent to a foundation or other structure prior to the building or house being unloaded from the transporter, to simplify the adjustments necessary to properly position the house upon the foundation.

The house transporters in the prior art do not readily allow the house to be conveniently adjusted for levelness, planarity, height, and angular and horizontal alignment on a substantially continuous basis during transport.

### SUMMARY

One embodiment of the present invention relates to a transport device for a load, a portion of the load defining a plane. The transport device includes at least one device configured to alter the orientation of the load relative to at least a portion of the transport device. At least one sensor is adapted to detect if at least one of the following occurs: the portion of the load becomes substantially non-planar and the portion of the load becomes substantially non-level. Electrical components are in communication with the sensor and are adapted to adjust at least one device such that the portion of the load maintains at least one of the substantial planarity and the substantial levelness.

Another embodiment of the present invention relates to a building carrier. The carrier includes a first steerable device, a second steerable device, and a means for coupling the first steerable device to the second steerable device, the coupled first and second steerable devices capable of supporting a building. A first actuator is coupled to the first steerable device and a second actuator is coupled to the second steerable device. An electrical system is in communication with the first and second actuator and configured to maintain the building in a substantially level and/or in-plane position.

Another embodiment of the present invention relates to a method of transporting a building in a level manner. The method includes the steps of positioning the building on a transport device, sensing the position of the building, and altering the orientation of the building based on the sensed position of the building using electrical circuitry in communication with actuators, while maintaining substantial planarity and levelness of the load.

Additional features and advantages are described herein, and will be apparent from, the following Detailed Description and the figures.

### BRIEF DESCRIPTION OF THE FIGURES

FIG. 1 illustrates two separate vehicles that can connect together and move buildings according to one embodiment of the present invention;

FIG. 2 is a top perspective view of the vehicles of FIG. 1 connected together using beams;

FIG. 3 is a top perspective view of the vehicles of FIG. 1 connected together with a building positioned therebetween;

FIG. 4 is a top view of the vehicle and building of FIG. 3;

FIG. 5 is a side view of the vehicle and building of FIG. 4;

FIG. 6 is a top perspective view of one of the beams shown in FIG. 2 for coupling the two vehicles together;

FIG. 7 is an enlarged view of one end of the beam of FIG. 6;

FIG. 8 is a side view of one of the vehicles illustrated in FIG. 1;

FIG. 9 is a top view of the vehicle of FIG. 8;

FIG. 10 is an enlarged partial side view of the vehicle of FIG. 8;

FIG. 11 is enlarged top perspective partial view of one end of the vehicle of FIG. 10, showing the linkage and pivots between a bogie and the chassis;

FIG. 12 is a top perspective view in section of an axle of one of the bogies for the vehicle shown in FIG. 11;

FIG. 13 is a schematic top view representation of the vehicle of FIG. 2 transporting a building in crabbing mode to a predetermined site;

FIG. 14 is a schematic view of a system configured to maintain a load in a substantial planar and substantial level orientation according to one embodiment of the present invention;

FIG. 15 is a schematic top view representation of the vehicle of FIG. 3 in transition from cruise mode to pull in mode showing the vehicle orienting the building for pulling into the predetermined site;

FIG. 16; is a schematic top view representation of the vehicle of FIG. 3 pulling into the predetermined site;

FIG. 17 is a schematic top view representation of the vehicle of FIG. 16 positioning the building over an existing foundation;

FIG. 18 is a schematic side view representation of the vehicle of FIG. 17; and

FIG. 19 is a schematic side view representation of the vehicle of 18 lowering the building onto the existing foundation;

### DETAILED DESCRIPTION

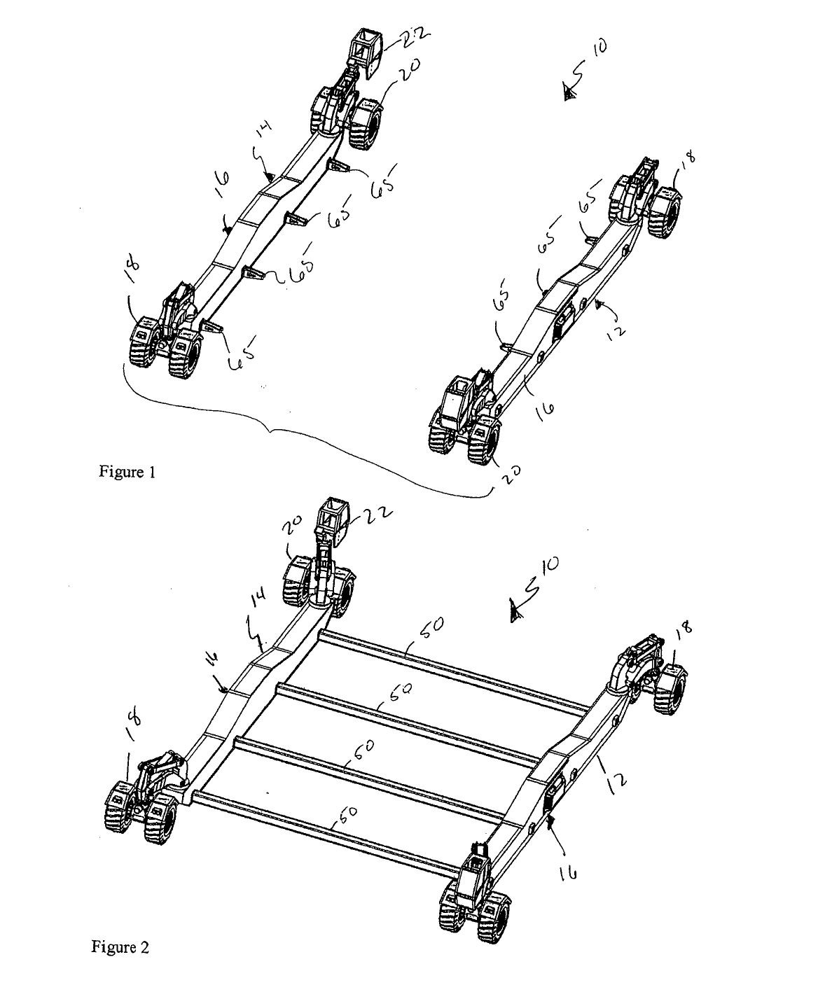

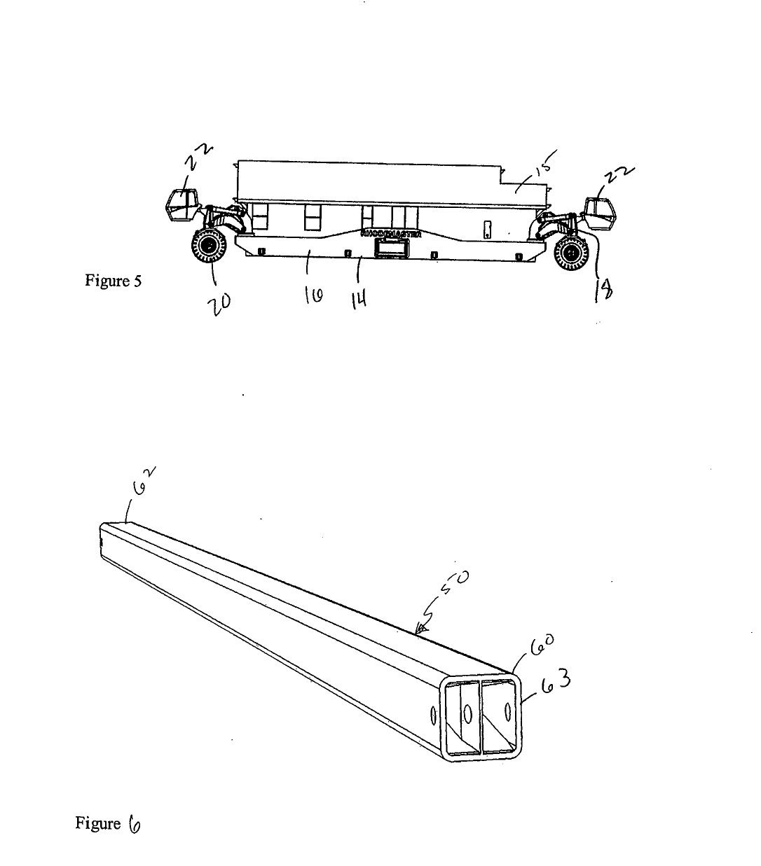

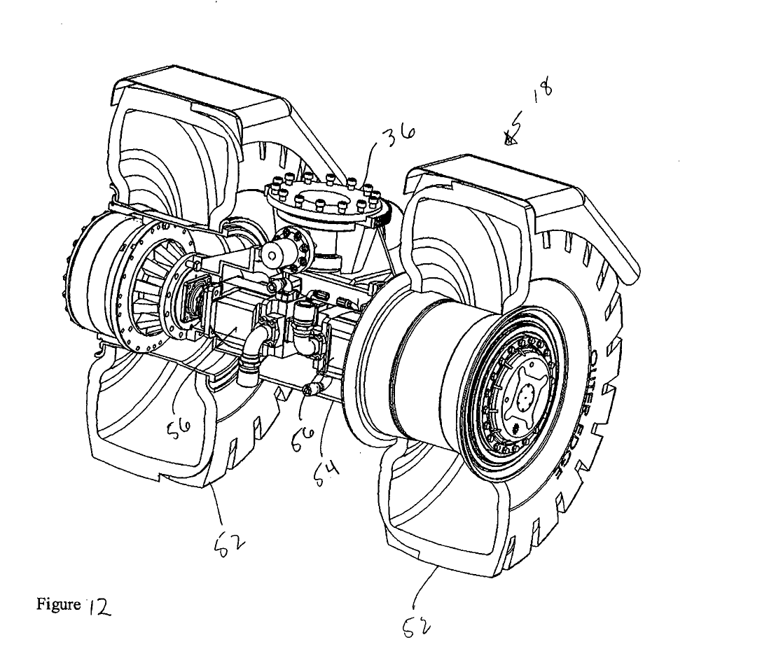

FIGS. 1-12 illustrate a building transport vehicle 10 according to the present invention. The transport device is configured to transport any suitable building or load by maintaining the load in a substantially level and substantially planar configuration and/or orientation. Such configuration and/or orientation of the load facilitates prevention of structural and/or cosmetic damage of the load during transport.

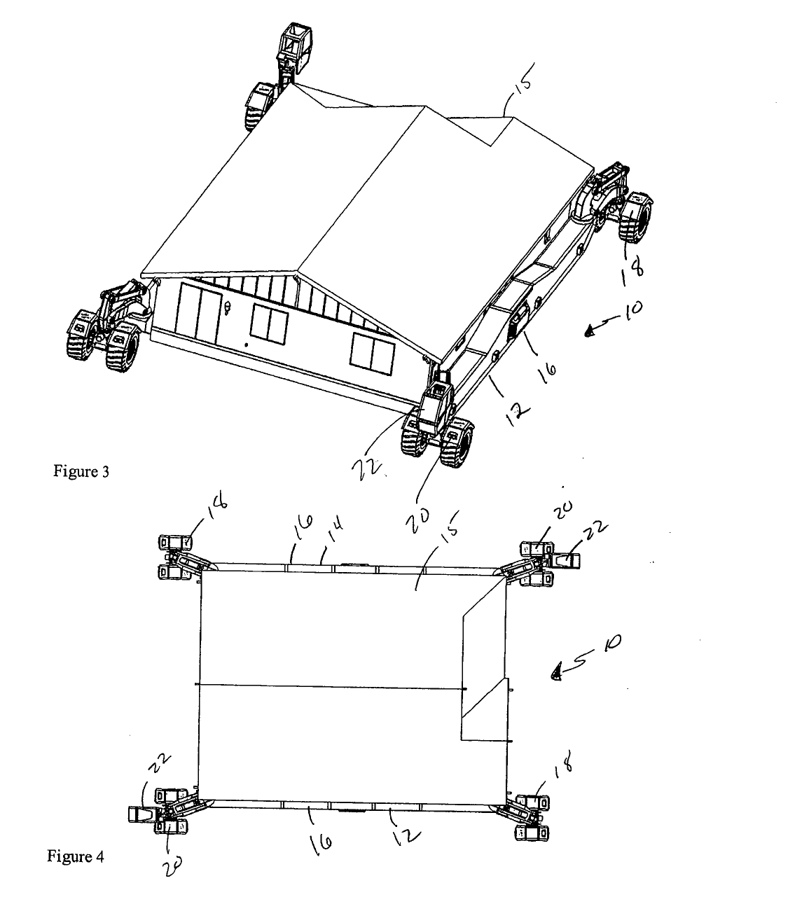

Building is defined as any completed, substantially completed or partially completed structure capable of permanent, semi-permanent or temporary occupancy or a house or other large rigid or semi-rigid payload. For example, a house can be a standard sized home, too large to be transported on public roads, a double wide or triple wide mobile home or any other structure desired. As shown in FIG. 1, the transport vehicle generally consists of a first independent transport vehicle or support structure 12 and a second independent transport vehicle or support structure 14; however, the vehicle 10 can include any number of suitable vehicles. Preferably, vehicles 12 and 14 couple together in any suitable manner and are configured to transport a house or building 15, as shown in FIGS. 3-5.

Prefereably, the first and second vehicles are substantially similar and can either operate alone or in combination. Therefore, the description of vehicle 12 is applicable to both vehicles 12 and 14; however, the vehicles can each be designed in any suitable manner and do not necessarily need to be substantially similar.

When operating in combination, the vehicles preferably are coupled together using beams 50 (or any other suitable means) and are preferably in electrical communication. One of the vehicles preferably is the dominant vehicle and will control the overall operation (i.e., the vehicles operate in a master-slave relationship); however, it is not necessary for each vehicle to be able to operate independently nor is it necessary for one of the vehicles to be the dominant vehicle.

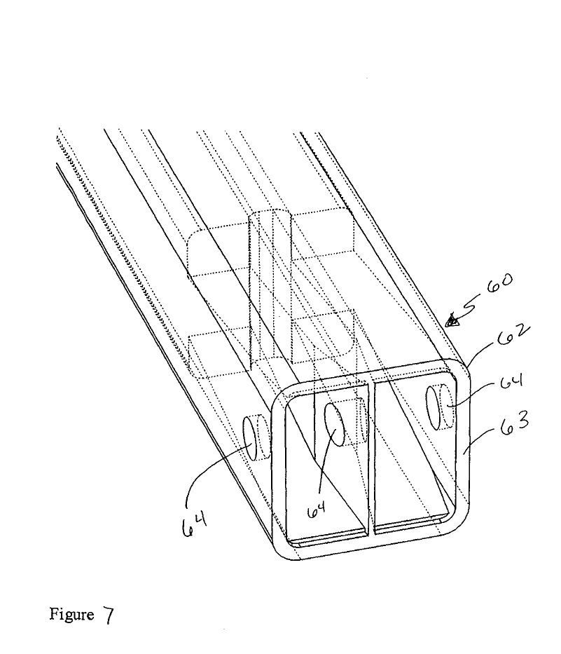

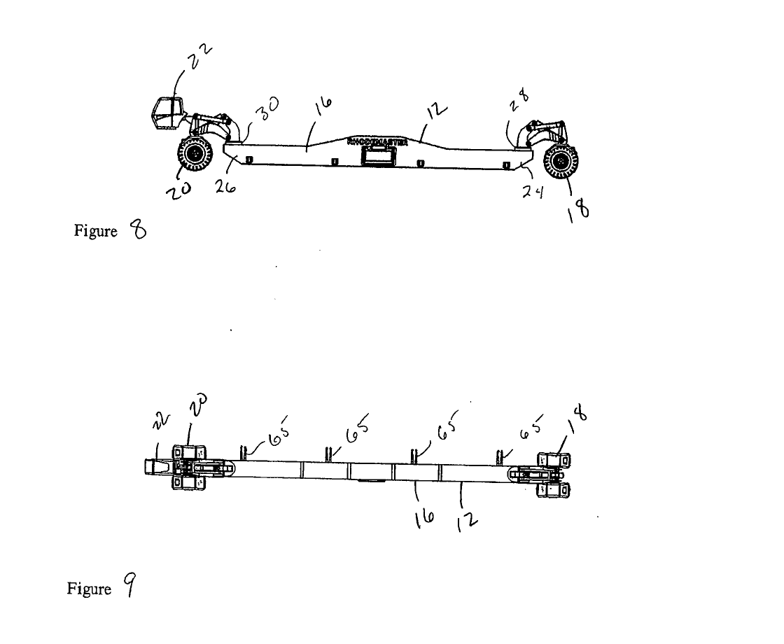

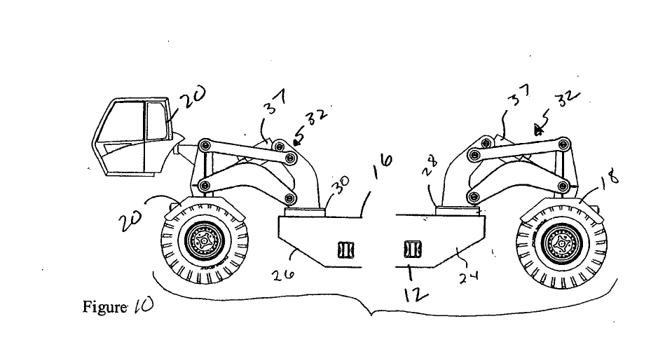

FIG. 3 illustrates “load mode” for the transport vehicle 10. In “load mode”, independent vehicles 12 and 14 couple together using beams 50 (FIG. 2) of house 15. Beams 50 are prefereably formed from steel, but can be any suitable material or combination of composition of materials. As shown in FIG. 6 and 7, each beam 50 has a first end 60 and a second end 62. Each end of the beam has a receiver 63 that accepts a matching fork 65 that protrudes from the chassis (FIG. 1). The fork is hydraulically operated. It registers into the receiver and then clamps to it to provide a structural joint during transport. The joint is preferably secured by hydraulically or electrically clamping the stabs to the sockets in the beams bolts. It is noted that the beams can be connected to the chassis in any suitable manner. Additionally, the beams 50 can be integral with the structure of the building or separate to the structure of the building. Thus, when loading the vehicles 12 and 14 with the house, the house can be merely positioned on the beams 50, connected or coupled thereto in a suitable manner or integrally joined with the beams 50. The beams can be a structural component of the building or not.

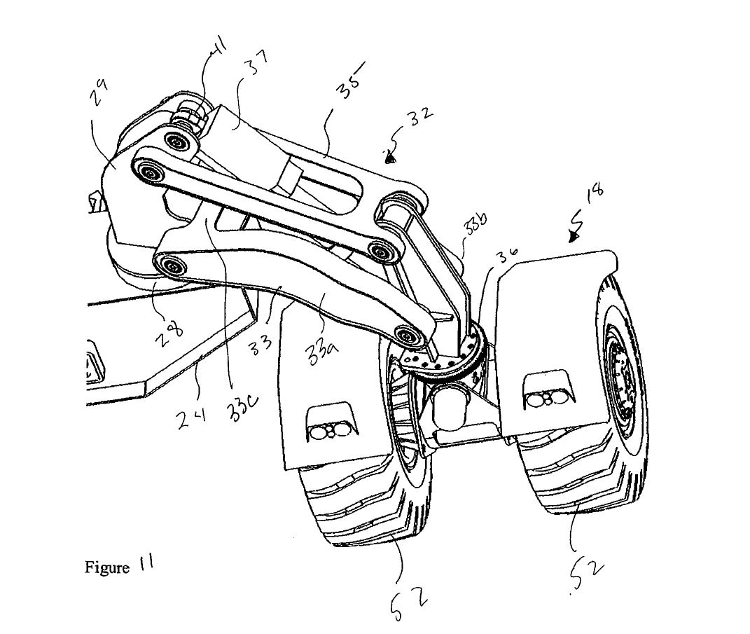

As shown in FIGS. 8 and 9, each vehicle preferably includes a truss or chassis 16, a first bogie 18, a second bogie 20 and a control station 22. The chassis 16 is preferably manufactured from welded plate sections but can be any suitable design and/or configuration, such as being manufactured from welded tubes. Each chassis is generally about 60 feet long, about 44 inches wide, about 92 inches high and weighs approximately 40,000 pounds, including internal equipment; however the chassis can have any suitable dimensions and/or weight as appropriate for the building or load size and weight. Preferably chassis 16 is designed and configured to provide minimal loaded deflection and cope with torsional load when the bogies are offset.

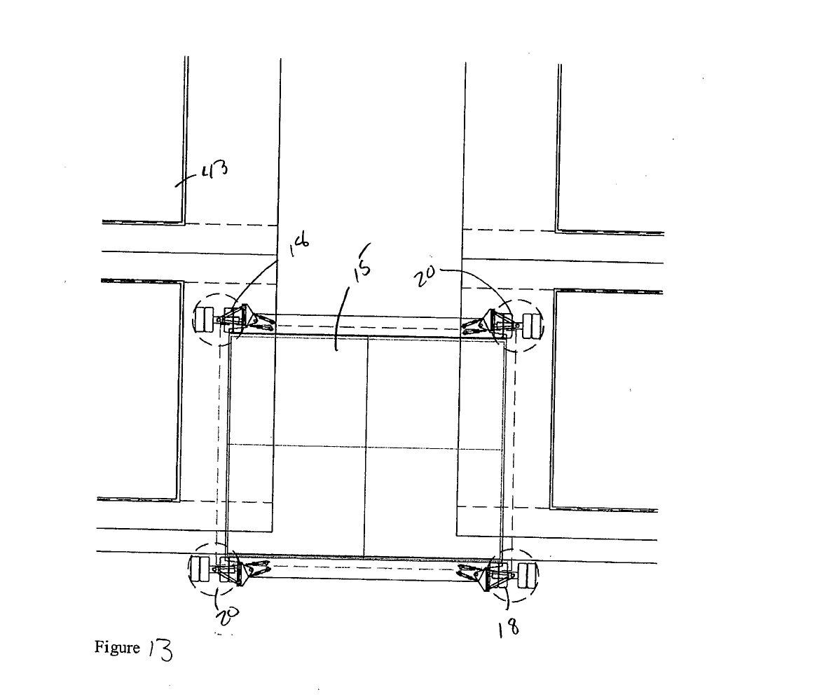

As shown in FIGS. 8-10, chassis 16 has a first end 24 and a second end 26, each of which is coupled to a respective bogie via actively articulated slewing ring bearings 28 and 30, respectively. The ring bearings do not necessarily need to be actively articulated and can be any bearings desired. Furthermore, the chassis can be coupled to the bogies in any suitable manner, such as with a stub axle or being hingedly coupled to a yoke or connecting arm. Preferably, each slewing ring bearing has a coupling member or protrusion 29 extending therefrom, as shown in FIG. 11. A four-bar parallelogram linkage 32 couples the protrusion 29 on the slewing ring to a rotation pivot 36 on each bogie. The combination of linkage 32 and the ring bearings can allow adjustment of the load. Linkage 32 preferably includes an arcuate or boomerang shaped link 33 having a first portion 33a and a second portion 33b. Portions 33a and 33b are preferably unitarily attached using member 33c, but do not need to be unitary and can be coupled together in any manner desired. Linkage 32 also includes U-shaped linkage 35. Each link is driven by a dedicated hydraulic actuator 37, such that as the actuator extends, the bogie lowers relative to the chassis 16. Preferably one end of the actuator is coupled to protrusion 29 and the opposite end is coupled to the rotation pivot; however, the actuator can be configured in any suitable manner. The actuator may be either a conventional hydraulic servoactuator, or a counterbalance cylinder concentric and working in parallel with a smaller servoactuator or an electromechanical actuator or any other similar means of actuation.

The actuators 37 preferably have a dynamic lifting capacity of at least 200,000 lb each with a 10-inch bore and a 38-inch stroke, but can have any suitable lifting capacity. The bogie travel in the vertical direction is preferably about six feet, but can be any suitable distance. In particular, the conventional servoactuators can be hydraulic actuators with integral position feedback and pressure transducers for load feedback that lift and support the payload.

In another embodiment, counterbalanced actuators can be utilized, which are smaller hydraulic actuators connected to a constant pressure source to lift and support a significant portion of the payload weight. That is, the large conventional servo actuators could be replaced by a smaller counterbalance actuator with a smaller servo actuator mechanically connected in parallel. The counterbalance actuator will support most of the payload's dead weight with the smaller servo actuator only required to actively position the payload

The slewing ring bearing has a range of plus or minus 40 degrees where zero is straight ahead (or any suitable degree) of angular motion. The slewing ring bearing preferably enables the wheel track of a specific vehicle to vary about 15 feet from the nominal house width or it can vary from about 40 feet to about 55 feet, but the wheel track can vary in any suitable amount.

While transporting the house to a particular or predetermined site 43 or operating in “cruise mode”, the bogies are preferably set so that the shortest face of the house is facing forward (i.e., transverse to each chassis, as shown in FIGS. 3 and 4) and the bogies are set at their narrowest position. That is, the bogies can be “tucked in” to their narrow most position, so that the wheels can run on the roadways or traverse other possibly narrow areas in route to the predetermined site 43. However, it is noted that the bogies can operate in any position desired or suitable during any of the steps of transporting or positioning the building or house.

The four-bar parallelogram linkage 32 and slewing ring structure 29 allow for final positioning of the house over the foundation 45 in “set mode”. Through coordinated and controlled movement of the slewing ring bearings, combined with controlled movement in a straight line of the bogies along the side edges of the foundation, the transport device 10 achieves sufficient latitudinal, longitudinal, and rotational movement over a small range to allow the operators to precisely align the house with its foundation.

In another embodiment, the chassis 16 can be hingedly coupled to the bogie via a yoke. Each yoke can be independently adjusted using two hydraulic pistons or actuators. Preferably, each yoke is coupled to the chassis using a first rotational pivot and a second hinge, but may be coupled to the chassis in any suitable manner. Preferably, the pivots allow the yoke to swing through an arc that is substantially parallel to the ground. The yoke extends to a respective bogie and connects to one end of an actuator. The yoke is coupled to one end of the actuator.

Additionally, in this embodiment, each bogie has an actuator with a first end and a second end coupled thereto. The first end is coupled to the connecting arm and the second end is coupled to a ball joint, which is in turn connected to the bogie itself. The ball joints enable each ram to equalize the load over and negotiate uneven terrain.

As shown in FIG. 12, each bogie preferably has two wheels 52, but can have any number of suitable wheels. For example, each bogie can have eight wheels, four wheels or any number of wheels that would allow vehicle 12 to operate independently of vehicle 14.

Preferably each independent vehicle has a first bogie 18 and a second bogie 20 and therefore when combined, the transport vehicle has four bogies, one at each corner; but it is noted that each independent vehicle can have any number of suitable bogies. Preferably, each bogie has two driven wheels 52; but can have any number of suitably driven wheels (e.g. each bogie can have 1, 3, 4 or more driven wheels). Wheels 52 are on an axle 54 with each wheel being driven by a separate hydraulic motor 56, but they can be driven in any suitable manner. The transport vehicle velocity and steering is controlled by independently controlling the velocity of the wheels on the left and right side of the bogie (known as differential steering). By driving and steering the four independent bogies, the velocity, the direction of rotation and heading of the vehicle as a whole can be precisely controlled.

In each mode of operation, the desired velocity vector is calculated at each moment based on inputs from the operators and the onboard guidance and navigation systems. To achieve the desired position, differential steering of each bogie is used to advance and rotate the vehicle as required. To minimize stresses on the vehicle and the payload, algorithms can used to calculate an “instant center” about which to rotate the vehicle. This “instant center” may be under the vehicle or some distance away, based on the desired movement of the vehicle 10. At each moment, the four bogies are driven to align such that their direction of travel is perpendicular to a radial line drawn from the instant center to the bogie center. When the vehicle is traveling in a straight line the instant center is an infinite distance from the vehicle. The angle of advance can be in any direction within the steering range between the bogie axle and linkage (plus or minus 180 degrees) in either forward or reverse direction. However, it is noted that it is not necessary to steer the vehicle 10 in this manner and the vehicle can be merely steered by the operator or operators or computer control or other suitable means.

One end of each independent vehicle has a driver's cabin 22 situated over the bogie and is configured to rotate in any suitable manner. For example, each cabin can rotate up to and including 180 degrees (or any other suitable amount) or, alternatively, the driver and his seat can rotate relative to the cabin. Preferably, the driver's cabin is situated to be a high visibility air conditioned station that allows the driver to control the independent vehicle; however, the driver's cabin can be any suitable steering platform and can be positioned in any suitable area of the vehicle. Additionally, it is not necessary for each vehicle 12 and 14 to have a driver's cabin or steering ability and only one of the vehicles can be equipped with such capabilities or the vehicle can be remote controlled, controlled via artificial intelligence or computer, run on a track or follow a preprogrammed course or by any other suitable means.

Fine positioning of each independent vehicle preferably occurs under the control of an operator in the cab and/or one at a remote pendant that can be positioned in any suitable manner, such as outside of the cab or remote from the cab. One independent vehicle is positioned such that its cab is at the back of the building and the other such that its cab is at the front or in any other suitable manner. Once the two independent vehicles are precisely located, the payload is attached (i.e., “load mode”) using the beams, as described above. Two inter-connect cables between the two independent vehicles are preferably connected, one at the front of the building or load and one at the back, so that the vehicles can operate as one unit in a master-slave arrangement. Once in this configuration, the load is lifted by the vehicle. However, it is noted that the vehicles can couple in any suitable manner and do not necessarily need to be electrically coupled in this manner or approach and position themselves in this manner. The herein described “load mode” is merely exemplary (as is each herein described “mode”) and the vehicles can be loaded and connected in any suitable manner.

With the house loaded, one independent vehicle can be selected as the master and the other as the slave using a selection switch on each console or any in other suitable manner. While operating in “cruise mode”, the cab at the front is typically the master and the one at the rear is the slave. When entering “cruise mode”, an onboard computer system confirms that the two inter-connect cables are attached and that one cab is set as master and one is set as slave. The onboard computer system also confirms that all load sensors are within nominal range and that the house is level and/or planar within tolerance as well as other suitable tests as may be required to verify that it is safe to change modes. At this point, the master cab operator can begin moving the vehicle.

As vehicle 10 pulls away, all four bogies can be folded in to their fully retracted position. Such positioning would allow the overall wheel track to be narrow enough to pass through potentially narrow areas, for example as shown in FIG. 3; however, the bogies can be positioned in any desired configuration. FIG. 3 is merely for exemplary purposes of the “cruise mode” and is not meant to limit the structure of the herein described vehicle. Folding to this position can be achieved by means of a switch on the console or by any other suitable means. At this point, as the vehicle drives forward, the slewing ring bearings fold in automatically. However, as noted above, the bogies can be positioned in any desired or suitable position at any time during loading, setting or transporting the building or house 15.

While driving, two operators, one in each cab, preferably control the vehicle's motion while communicating to each other over headsets; however it is not necessary for the operators to communicate in the manner, to communicate at all or for there even to be two operators. The vehicle can operate with any suitable number of operators and/or the operators can be positioned remotely from the vehicle and communicate with the vehicle from wired or wireless means or the vehicles can be computer controlled or automated. From each of the operators' points of view, each feels as if they are driving their own corner of the vehicle via a steering wheel or joystick on the console (not shown). The onboard computer system achieves such operation by generating steering and speed commands for all four bogies based on the input of the two joysticks. In this way, the operators can navigate fairly tight corners. The overall velocity is governed primarily by the master (front) operator. Both operators must maintain pressure on a dead-man enable switch (not shown) to enable motion.

Preferably, the house is maintained in a substantially planar and/or substantially level position throughout its conveyance to a predetermined position or location. Sensors or other suitable means monitor the angle of the house with respect to a gravity vector while other sensors or means measure the pitch angle induced on the bogies due to the slope of the ground. Based on this input, the onboard computer system causes the servoactuators 37 at each bogie to adjust accordingly to maintain level. In all modes, this leveling action supersedes the travel velocity in so far as the onboard computer system will automatically slow down the wheels to accommodate the leveling response time as necessary. If the system should ever reach the threshold where proper leveling cannot be maintained, the onboard computer system can command a reduced speed, or, if necessary, invoke an Automatic Stop, bringing forward travel to a halt at a suitable speed or deceleration.

FIG. 14 is a schematic representation of the onboard self-leveling system. This system allows a load or building to be transported from one site (such as the manufacturing or building site) to a second site (such as the foundation or final position for the building).

When traversing a road surface 100 the roughness or other unevenness of the road can and generally does induce motion through the tire and lift system 102, the actuator geometry 104, and actuator 106. Preferably information from each bogie and/or servoactuator 106 is sent to the vehicle controller 108. That is, the leveling system preferably receives data from sensors on each of the four hydraulic cylinders located on each bogie (for example, bogies 18 and 20 and actuator 37); however, the system can receive input from any number of suitable hydraulic actuator sensors or other means. The sensors on the actuators then send signals identifying their position and pressure feedback to both the controller card 110 and the vehicle controller 108. Additionally, at substantially the same time or on a continual basis, leveling sensors and/or planarity sensors (e.g., strain gages attached to the house floor structure or laser alignment devices) 112 send a signal to the vehicle controller. Prefereably the leveling sensors and/or planarity sensors 112 send signals at specific intervals; however, the sensors can send signals on any desired schedule. The leveling sensors and/or planarity sensors 112 can include one device or any other number of suitable sensors.

The vehicle controller 108 processes the information from the actuator 106 and the leveling sensors and/or planarity sensors 112 and sends a commanded position to the controller card 110. For example, as stated above, the sensors and/or planarity sensors 112 can be any suitable means for monitoring the angle of the house with respect to a gravity vector and/or other means that measure the planarity of the vehicle chassis using at least three points directly under the slewing ring bearings or other suitable locations.

The controller card 110 then using the data or information received from the vehicle controller 108, the sensors 112 and/or the hydraulic cylinder(s) 106 relays or sends valve commands to the proportional valve(s) 114. The valve(s) in turn control the hydraulic cylinder(s) to adjust the height of the building or portion of the building overlying the specific hydraulic cylinder. Such a system enables the vehicle to continually monitor the position of the building and adjust as the vehicle transports the building to a specific site.

While this leveling and or planarity system is preferably used with a transport vehicle that is formed from two separately joined vehicles, this system can be used with any suitable transport vehicle, including a unitarily constructed vehicle or a vehicle formed from any number of other separately joined vehicles.

Using “cruise mode”, the vehicle is brought to the vicinity of the foundation 45 onto which the building or house will be placed. Depending on the exact geometry of the final location, the operators will have a specific target range of position and orientation to park the vehicle 10 before switching over to “pull in” mode. The onboard display preferably will indicate when the vehicle is within the proper range based on GPS readings by onboard receivers or by any other suitable method or device.

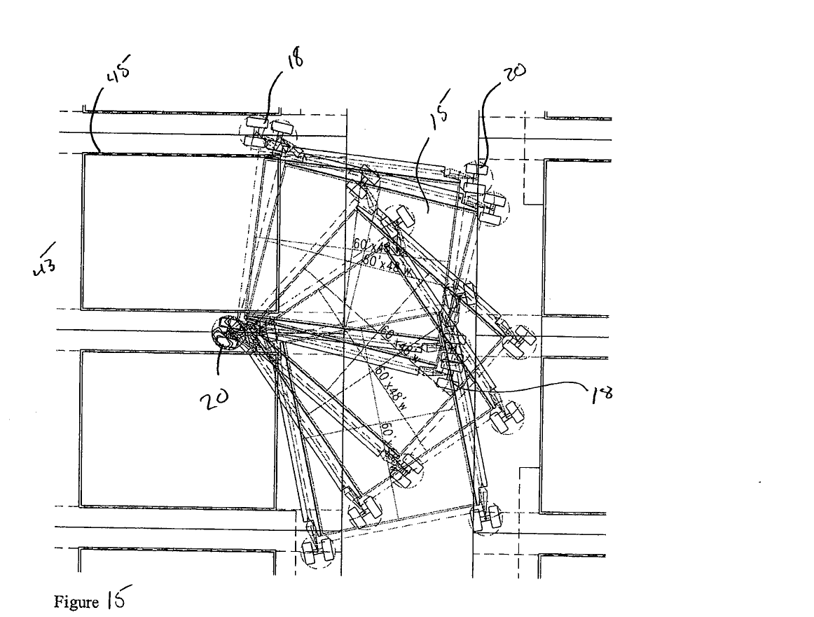

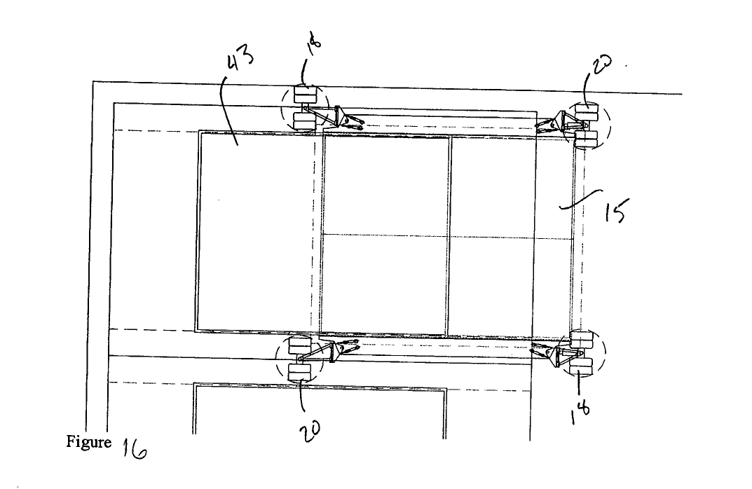

As shown in FIG. 15, the bogies are capable of turning in place to transition from cruise mode, where the short side of the house is leading, to “crab mode”, where the long side of the house leads. In crab mode, the wheels are rotated 90 degrees and the slewing ring bearings are arranged to minimize the overall width of the vehicle. This orientation aligns the house with the foundation at the preselected site and sets the transport vehicle for “pull-in mode”. During the pull-in maneuver to position the house at the predetermined site 43, the leading bogies can splay out to clear the house foundation 45, as shown in FIG. 15.

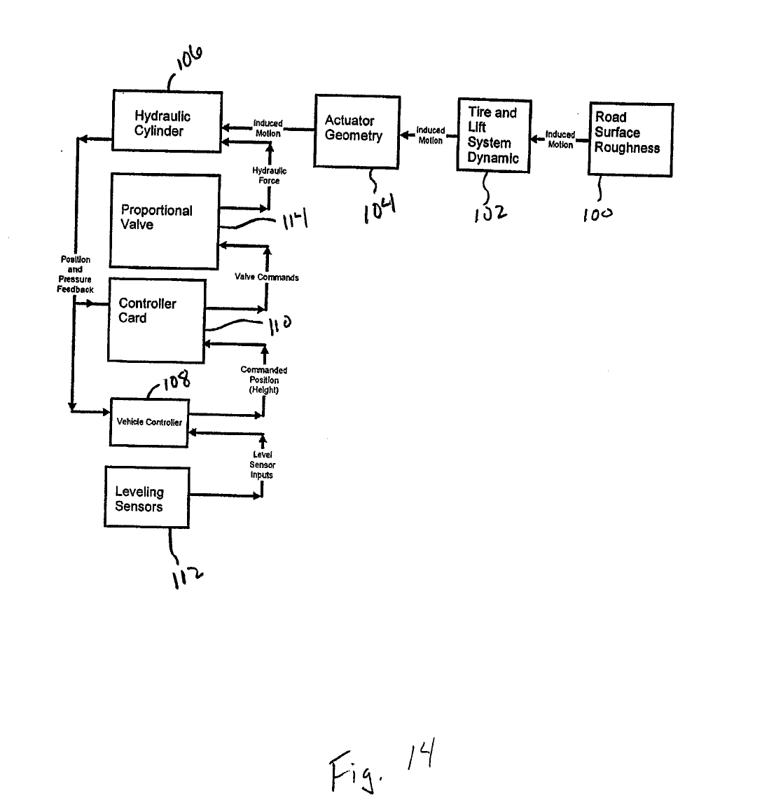

Additionally, “crab mode” can be implemented as the vehicle approaches the house foundation. The vehicle transitions from “cruise mode” configuration to “crab mode” configuration at some point before the vehicle arrives on the street where the house will be located. The vehicle then proceeds down the street with the house sideways, i.e. the side of the house is leading. Once the vehicle aligns the house with its foundation, the bogies rotate 90 degrees (see FIG. 13), the leading bogies splay outwards, as discussed above.

The advantage using the “crab mode” maneuver prior to arrival at the site 43 is that it does not require that one of the adjacent foundations be empty in order to set the house, as may required by the pull-in maneuver, depending on the specific set-up and/or configuration of the adjacent buildings.

As shown in FIG. 16, “pull-in mode” preferably begins with a laser beacon (not shown) or any other suitable device or method being placed on a survey point at the back of the foundation or in other suitable position, as a precise reference point. FIG. 16 is merely a schematic drawing of the bogies and is not a full drawing of each independent vehicle, including the chassis and cabs. This figure is merely for exemplary purposes of the “pull-in mode” and is not meant to limit the structure of the herein described vehicle. When the system is switched into “pull-in mode”, the onboard computer system checks to make sure that the vehicle is within the correct starting range using both the GPS receivers and two sensors receiving the rotating beam from the laser beacon. If all the inputs are consistent, the system will indicate that it is ready to begin the automated procedure of pulling in.

The operator then ensures that the path ahead is clear and initiates motion by means of a pushbutton. The vehicle then begins moving at a “creep speed”, which it will maintain throughout the pull in procedure. The operators can have the capability to slightly adjust the motion by way of their joysticks and both must keep pressure on their respective dead-man enable switches.

The onboard computer system automatically drives the vehicle to a precise location and orientation. As the vehicle automatically maneuvers to the known point, the system splays out the two front yokes as needed to fit outside the foundation. When the vehicle reaches the front of the foundation, it will stop and allow the operators to confirm the location visually.

Preferably, the splay of the lead bogie occurs during pull-in and the rear outer-most bogie remains in full tuck position; however, each or all of the bogies can be positioned in any suitable position and are not limited to the specific positions described herein.

If both operators are satisfied with the starting position, they re-enable motion through the console or in any other suitable manner. The vehicle drives in over the foundation while rotating the house to its correct orientation. This maneuver is preferably pre-programmed and customized for the particular location and associated obstacles; but may be performed in any suitable manner. It generally involves coordinated motion of the bogies and the slewing ring bearings throughout the motion. Prefereably, the operators continue to have fine adjustment capability and continuously enable the motion. The automatically leveling system continues to be active throughout this maneuver. Additionally, fine adjustments could be made with slewing ring bearings, but lateral movement of the bogies occurs over a distance unless the vehicle stops and the bogie rotates in place to be perpendicular to the linkage. A pure side shift maneuver may then be accomplished. Then, the bogie would be reoriented to point according to the command from the on board computer system and the automatic maneuver resumed.

To complete the pull-in procedure, the onboard computer system automatically stops the vehicle when it is within a specific range of the final position as detected by laser and GPS positioning system or any other suitable device or method. At this point, the bogies are maneuvered to be near the mid-range of their splay range to permit maximum maneuverability during the subsequent set mode.

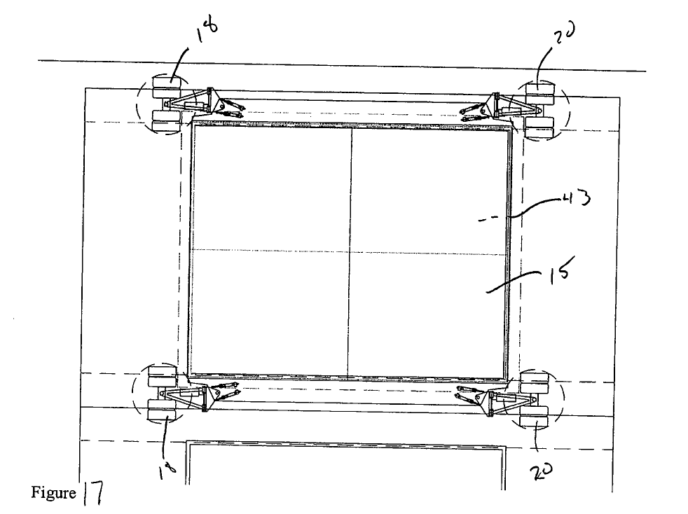

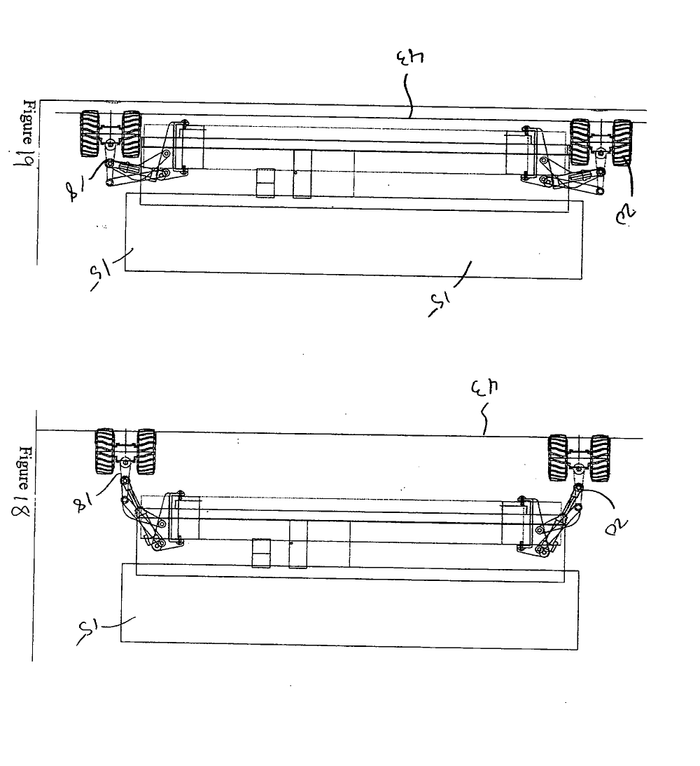

Final positioning of the house on the foundation is accomplished in “set mode”, as shown in FIGS. 17-19. FIGS. 17-19 are merely schematic drawings of the bogies and are not full drawings of each independent vehicle, including the chassis and cabs. These figures are merely for exemplary purposes of the “set mode” and are not meant to limit the structure of the herein described vehicle. In this mode the operators control can use any suitable method. For example, remote pendants can be attached to the outside of each cab, thus allowing the operators a better perspective for setting the house. Using a joy stick and rotary knob, for example, the operators can translate the house over a small range (e.g. an order of magnitude of approximately two feet) in any direction and rotate the house about its vertical axis up to ± approximately 5 degrees. However, it is noted that the controls can be inside the cab, wireless or wired remote controls or any other suitable controls and the variance of movement both laterally and vertically can be any suitable distance or angle.

This motion is accomplished by the onboard computer system commanding the motion of the four bogie slewing ring bearings and secondarily the bogies themselves to drive straight backward and forward a short distance along the foundation. No bogie steering is necessarily required, but can be used if desired.

Once the house is positioned over the foundation, the operator commands the system to lower the house down slowly. Fine position and rotations can continue to be made during lowering until the house is placed precisely on its mark. At this point, the vehicle is shut off while the house is mechanically decoupled (or decoupled in any suitable manner) from the vehicle and the two vehicle-halves are disconnected mechanically and electrically.

“Extract mode” is used to remove the vehicles 12 and 14 from between two houses after placing a house on its foundation. Because the space may be narrow, this maneuver can be accomplished by guiding both the front and rear bogie out under manual control. One bogie is controlled by the joystick in the cab while the other is controlled by an operator walking along side with a pendant or in any other suitable manner. Due to the nature of the combined vehicle in the preferred embodiment, one vehicle will likely be extracted cab first and the other tail first, but the vehicles can be extracted in any manner desired. Once the vehicles become clear of the foundations and other obstacles around the buildings, they can be steered onto the roadway. When they are completely clear, the pendant is stowed and the vehicle is switched to “Go-Home mode” for the drive back to the factory. Automatic leveling or planarity is not active in “extract mode”, but the operator has the ability to manually raise or lower each end as required and/or desired. In addition, the axle roll degree of freedom is stiffened to enhance stability of the vehicle in this mode. The herein described “extract mode” is merely exemplary and the vehicles do not necessarily need to perform each step as described herein or perform each step in the same manner as described.

If the cross beams 50 are not integral with the house, they must be extracted laterally from the foundation using a small vehicle, such as a Bobcat or in any other suitable manner. The beams are then transported out to the street in front of the house and can be loaded, for example, onto suitable brackets on the sides of each of the vehicles 12 and 14 or onto separate trucks as desired or in any other suitable manner.

“Go-home mode” is used to drive each half-vehicle back to the factory or any other suitable location. In this mode, a single operator sits in the cab and essentially drives the vehicle using the joystick or steering wheel and the dead-man switch. The onboard computer system will steer the vehicle in a natural-feeling fashion based on the operator's inputs. Automatic leveling is not active in this mode, but the operator has a limited ability to manually raise or lower each end as required and/or desired; however, the driver can have an unlimited ability to manually raise or lower each card if desired.

Since no leveling is required, the vehicle can travel up to its maximum speed of 10 MPH in this mode or any other suitable speed

It is noted that it is not necessary for the system to work in the above described specific manner and any portion or all of these maneuvers can be deleted, performed in any suitable order, can be automatic, computer controlled, manually controlled, or any combination thereof or in any other desired manner.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A transport device for a load, a portion of said load defining a plane, said device comprising:
at least one device configured to alter the orientation of the load relative to at least a portion of said transport device;
at least one sensor adapted to detect if at least one of the following occurs:
said portion of the load becomes substantially non-planar; and
said portion of the load becomes substantially non-level;
electrical components in communication with said sensor and adapted to adjust said at least one device such that said portion of said load maintains at least one of said substantial planarity and said substantial levelness.

2. A device according to claim 1, further comprising
first, second, third and fourth wheeled structures.

3. A device according to claim 2, wherein
said at least one device includes at least four actuators.

4. A device according to claim 3, wherein
said four actuators are coupled to said wheeled structures such that each of said wheeled structures has at least one actuator coupled thereto.

5. A device according to claim 1, wherein
said transport device is formed from two separate self propelled vehicles configured to couple together.

6. A device according to claim 1, further including
a plurality of accelerometers that communicate with said electrical components to facilitate maintaining said portion of said load in at least one of said substantial planar orientation and said substantial level orientation.

7. A device according to claim 1, wherein
said at least one sensor includes a plurality of inclinometers.

8. A device according to claim 1, wherein
said at least one sensor includes a rotating laser beacon on a damped gimbal.

9. A device according to claim 1, wherein
said load is a house.

10. A building carrier, comprising
a first steerable device;
a second steerable device;
a means for coupling said first steerable device to said second steerable device, said coupled first and second steerable devices capable of supporting a building;
a first actuator coupled to said first steerable device;
a second actuator coupled to said second steerable device; and
an electrical system in communication with said first and second actuators when said first and second steerable devices are coupled and configured to maintain said building in a substantially level and substantially planar orientation.

11. A building carrier according to claim 10, further comprising
at least one sensor in electrical communication with said electrical system and configured to determine the position of at least one of the building and building carrier relative to a gravity vector.

12. A building carrier according to claim 11, wherein
said at least one sensor includes a plurality of accelerometers that communicate with said electrical components to facilitate maintaining said building in said substantially level and substantially planar orientation.

13. A building carrier according to claim 11, wherein
said at least one sensor includes a plurality of inclinometers.

14. A building carrier according to claim 11, wherein
said at least one sensor includes a rotating laser beacon on a damped gimbal.

15. A building carrier according to claim 11, wherein
said first steerable device includes a first bogie and a second bogie, said first and second bogies each having at least two wheels; and
said second steerable device includes a third bogie and a fourth bogie, said third and fourth bogies each having at least two wheels.

16. A building carrier according to claim 15, wherein
each of said first, second, third and fourth bogies has at least one motive means configured to drive the two wheels thereon.

17. A building carrier according to claim 15, wherein
said first actuator is coupled to said first bogie; and
said second actuator is coupled to said second bogie.

18. A building carrier according to claim 17, further comprising
a third actuator coupled to said third bogie; and
a fourth actuator coupled to said fourth bogie;
wherein each of said bogies is located at approximately one corner of said building carrier.

19. A method of transporting a building in a substantially level and substantially planar manner, comprising the steps of
positioning the building on a transport device,
sensing the position of the building, and
altering the positioning of the building based on the sensed position of said building using electrical circuitry in communication with actuators.
